(19) United States
(12) Patent Application Publication
(10) Pub. No.: US 2007/0263068 A1
(43) Pub. Date: Nov. 15, 2007

(54) Mobile audio-video receiver with external memory receptacle

(75) Inventor: Suk Ki Hong, Santa Fe Springs, CA (US)

Correspondence Address: SEYFARTH SHAW, LLP, 815 CONNECTICUT AVENUE, N.W., SUITE 500, WASHINGTON, DC, 20006, US

(73) Assignee: NESA International Incorporated, Santa Fe Springs, CA (US)

(21) Appl. No.: 11/399,366

(22) Filed: Apr. 7, 2006

(51) Int. Cl. H04N 7/14

(52) U.S. Cl. 348/14.02

(57) ABSTRACT

A mobile audio-video receiver with an external memory receptacle includes a base containing circuitry and components for functions of the mobile audio-video receiver, a front panel mounted on a front surface of the base, a display screen on the front panel, function buttons on the front panel for controlling the functions of the mobile audio-video receiver, and the external memory receptacle positioned in a side surface of the base such that an externally accessible internal memory can be inserted into the base behind the front panel.

### BACKGROUND OF THE INVENTION

1. Field of the Invention

The present invention relates to a mobile audio-video receiver, and more particularly, to a mobile audio-video receiver with an external memory receptacle. Although the present invention is suitable for a wide scope of applications, it is particularly suitable for conveniently providing data to support a function of a mobile audio-video receiver.

2. Discussion of the Related Art

In general, a related art mobile audio-video receiver includes a control panel with a display screen for displaying an image, audio outputs for providing audio signals to speakers and internal memory for storing data to support functions of the mobile audio-video receiver. The receiver can function as a navigation system that is used to find a destination or other points of interest. The related art receiver can also function as an internal audio players within the receiver, such as an MP3 player, a WAV player or a compact disk player. Other types of external audio players can be attached to the receiver through an audio input port or a data input port configured for receiving signals from a predetermined device, such as an external compact disk changer. Further, the related art receiver can include internal audio/video players within the receiver, such as an MPEG player, a WMA player or a digital-video-disk (DVD) player. Other types of external audio/video players can be attached to the related receiver through an audio/video input port or a data input port configured for receiving signals from a predetermined device, such as an external digital video disk changer. Furthermore, the functions of the related art receiver can also include Television and FM/AM radio.

The internal memory of the related art mobile audio-video receiver can be used to store navigation data for the navigation function. Because navigation information changes, such internal memory has to be updated or changed. For example, in some related art mobile audio-video receiver having a navigation function, the receiver has to be removed from the dash and dissembled so that the internal memory can be physically changed with an up-to-date internal memory. However, the internal memory of other related art mobile audio-video receivers having a navigation function is provided with a data access connection to the internal memory, such as universal serial bus (USB) port or an infrared (IR) port, for updating the internal memory. A related art mobile audio-video receiver with a data access connection to the internal memory also includes a download function for memory management and updating the software of the receiver.

Audio data for the electronic memory type audio players, and audio/video data for the electronic memory type audio/video players can also be stored in the internal memory of a related art mobile audio-video receiver. A download function of the related art mobile audio-video receiver is used to add, delete and otherwise manage audio data and/or audio/video data. Typically, the download function of a related art mobile audio-video receiver is self-activated when a memory storage device is connected to the data access connection so that a user can download and/or manage the data of the internal memory.

Typically, the data access connection is on the front surface of the related art mobile audio-video receiver. The data access connection is unsightly, especially when an external memory storage device protrudes from the data access port. Although a data access port can be located on the side of the related art mobile audio-video receiver, an external memory storage device protruding from the side of the related art mobile audio-video receiver is unsightly. A download function as well as internal memory is needed to manage or use the external memory device located outside of the related art mobile audio-video receiver. Further, downloading to the related art mobile audio-video receiver is typically a two step process, since data is downloaded to the external memory storage device and then downloaded to the internal memory of the related art mobile audio-video receiver.

### SUMMARY OF THE INVENTION

Accordingly, the present invention is directed to a mobile audio-video receiver with an external memory receptacle that substantially obviates one or more of the problems due to limitations and disadvantages of the related art.

An object of the present invention is to provide an internal memory for a mobile audio-video receiver that can readily be removed.

Another object of the present invention is to provide an internal memory for a mobile audio-video receiver that is externally accessible.

Another object of the present invention is to provide theft deterrence for a mobile audio-video receiver.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the mobile audio-video receiver with an external memory receptacle includes a base containing circuitry and components for functions of the mobile audio-video receiver, a front panel mounted on a front surface of the base, a display screen on the front panel, function buttons on the front panel for controlling the functions of the mobile audio-video receiver, and the external memory receptacle is positioned in a side surface of the base such that an externally accessible internal memory can be inserted into the base behind the front panel.

In another aspect, a mobile audio-video receiver with an external memory receptacle includes a base containing circuitry and components for functions of the mobile audio-video receiver, a front panel mounted on a front surface of the base, a digital video disk player located behind the front panel, a display screen on the front panel, function buttons on the front panel for controlling the functions of the mobile audio-video receiver, the external memory receptacle positioned in a side surface of the base, and an externally accessible internal memory inserted into the external memory receptacle such that the externally accessible internal memory is in the base and behind the front panel.

In yet another aspect, a mobile audio-video receiver with an external memory receptacle including a base containing circuitry and components for functions of the mobile audio-video receiver, a sliding front panel mounted on a front surface of the base such that the front panel can slide down and away from the base, a digital-video-disk player located behind the sliding front panel, a display screen on the front panel, the external memory receptacle positioned in a side surface of the base, and an externally accessible internal memory completely inserted into the external memory receptacle such that the externally accessible internal memory is completely within the base and behind the sliding front panel, wherein at least some of the functions of the mobile audio-video receiver will not operate when the externally accessible internal memory is not installed in the memory receptacle.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a front view of a single-DIN sliding front mobile audio-video receiver according to an embodiment of the present invention.

FIG. 2 is a side view of the single-DIN sliding front mobile audio-video receiver shown in FIG. 1.

FIG. 3 is a front view of the single-DIN sliding front mobile audio-video receiver of FIG. 1 showing the insertion of an externally accessible internal memory.

FIG. 4 is a front view of a double-DIN sliding front mobile audio-video receiver according to an embodiment of the present invention.

FIG. 5 is a side view of the double-DIN sliding front mobile audio-video receiver shown in FIG. 4.

FIG. 6 is a front view of the double-DIN sliding front mobile audio-video receiver of FIG. 3 showing the insertion of an externally accessible internal memory.

### DETAILED DESCRIPTION OF THE PREFERRED EMBODIMENTS

Reference will now be made in detail to the preferred embodiments of the present invention, examples of which are illustrated in the accompanying drawings.

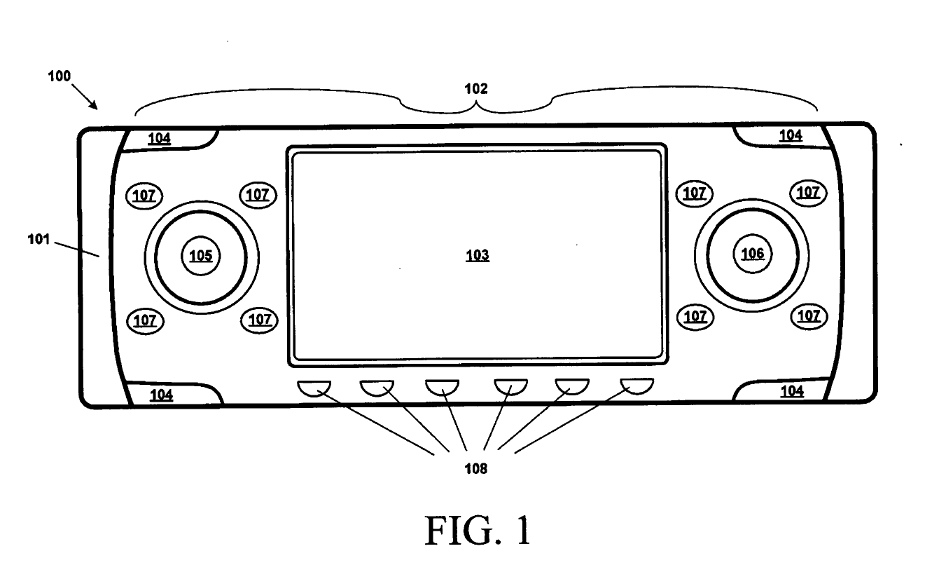

FIG. 1 is a front view of a single-DIN sliding front mobile audio-video receiver according to an embodiment of the present invention. The single-DIN sliding front mobile audio-video receiver 100 shown in FIG. 1 includes a base 101 having the circuitry and components for the functions of the mobile audio-video receiver 100. A front panel 102 mounted on the front surface of the base 101. The front panel 102 can be a sliding front panel that slides down and out from a base 101 to allow access to a DVD player behind the front panel 102. A display screen 103 is positioned at the center of the front panel 102. The display screen 103 can be a touch-panel display screen. Four function buttons 104 are positioned at corners of the front panel 102. A four-way rocker with a center button 105 is positioned on one side of the display screen 103 and a spinning controller with a center button 106 is positioned on the other side of the display screen 103. Additional function buttons 107 surround the four-way rocker with a center button 105 and the spinning controller with a center button 106. The front panel 102 also includes index control buttons 108 having functions commensurate to tabs on the display screen 103 that correspond to each of the control buttons 108.

The single-DIN sliding front mobile audio-video receiver 100 shown in FIG. 1 is an all-in-one system that includes a navigation system, a DVD player, memory-based audio players, radio and television receiver. To maintain an aesthetically appealing appearance, an electrically connectable memory port, such as a USB port or firewire port, for downloading electronic files can be provided behind the front panel 102. An IR port can be provided behind the front panel 102 or blended into the front of the front panel 102. As shown in FIG. 1, a front view of the mobile audio-video receiver 100 according to an embodiment of the present invention does not have an external memory or electrically connectable memory port visible when the front panel 102 is in the up position.

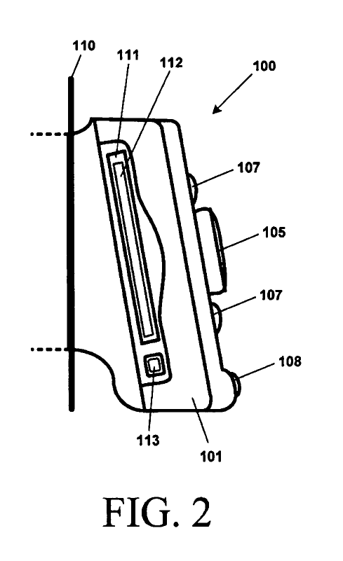

FIG. 2 is a side view of the single-DIN sliding front mobile audio-video receiver shown in FIG. 1. The base 101 of the mobile audio-video receiver 100 protrudes from the dash 110 or other mounting area of one of a vehicle or craft. An exterior side surface of the base 101 has a memory receptacle 111 for receiving an externally accessible internal memory 112. The memory receptacle 111 receives the externally accessible internal memory 112 such that the externally accessible internal memory 112 is within the mobile audio-video receiver 100. More particularly, the external memory receptacle 111 is in an exterior side surface of the base 101 and configured such that an externally accessible internal memory 112 can be completely inserted into the base 101 behind the front panel 102. Thus, the externally accessible internal memory 112 can be completely within the base of the mobile audio-video receiver 100. Because the externally accessible internal memory 112 can be inserted into the memory receptacle 111 such that the externally accessible internal memory 112 is completely within the mobile audio-video receiver 100, a memory eject button 113 located adjacent to the memory receptacle 111 is used to eject the externally accessible internal memory 112 from the mobile audio-video receiver 100.

The memory eject button 113 can be a mechanical eject button that ejects the externally accessible internal memory 112 via mechanical leverage. In the alternative, the memory button 113 can be an electro-mechanical eject button in which the button closes an electrical circuit that causes a solenoid to actuate so as to eject the externally accessible internal memory 112. An electro-mechanical eject button can be positioned anywhere on the exterior surface of the base 101 or on the sliding front 102 outside of the display 103.

The memory receptacle 111 can be configured to receive one of several different types of memory storage devices for use as the externally accessible internal memory 112. The externally accessible internal memory 112 can be a memory card using electronic memory or a memory drive using an electro-mechanical device. Examples of memory cards for which the memory receptacle 111 can be configured include memory stick, Xd memory, compact flash (CF) card and secure digital (SD) memory. Examples of memory drive for which the memory receptacle 111 can be configured include CF drive, microdrive and other types of small hard drives.

The externally accessible internal memory 112 can include the operating system for the functions of the mobile audio-video receiver 100 as well as the data used by the functions of the receiver. For example, the externally accessible internal memory 112 can include the navigation data for the navigation system and MP3's for the MP3 player of the mobile audio-video receiver 100. If the externally accessible internal memory 112 is not installed with the data for those functions, then at least those functions will not work. Such data can be directly loaded onto the externally accessible internal memory from a personal computer via the appropriate port or an adaptor for the externally accessible internal memory 112.

If the operating system of the mobile audio-video receiver is on the externally accessible internal memory, the externally accessible internal memory must be installed so that the mobile audio-video receiver will operate. In other words, removal of the externally accessible internal memory prohibits the use of the mobile audio-video receiver. Accordingly, the externally accessible internal memory can be used for theft deterrence by publicizing that such a mobile audio-video receiver is inoperable without the proper externally accessible internal memory installed.

Encoding techniques can be used with the externally accessible internal memory for theft deterrence. For example, recording of an access code specific to the mobile audio-video receiver from the externally accessible internal memory can be required prior to the mobile audio-video receiver becoming operational. A computer program can be provided with the mobile audio-video receiver 100 for encoding the externally accessible internal memory with the proper data to specifically operate the mobile audio-video receiver.

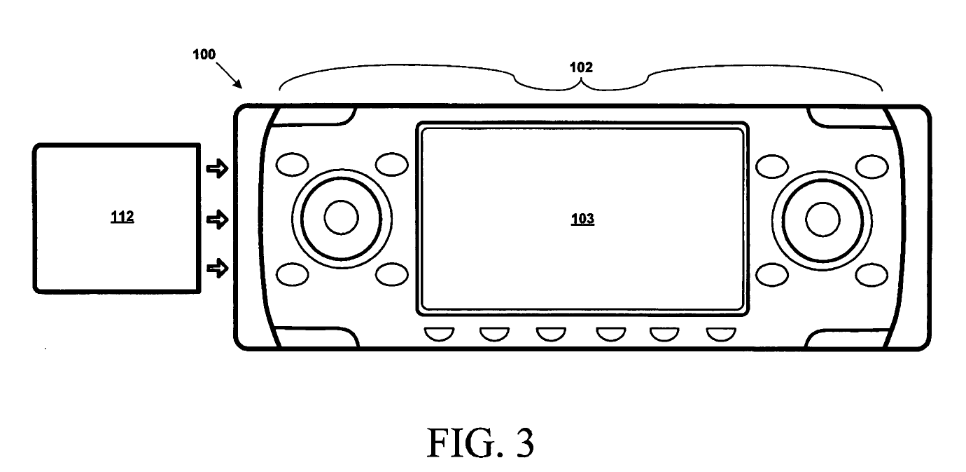

FIG. 3 is a front view of the single-DIN sliding front mobile audio-video receiver of FIG. 1 showing the insertion of an externally accessible internal memory. Because the mobile audio-video receiver protrudes from the dash, the externally accessible internal memory 112 can be inserted into the side of the mobile audio-video receiver 100, as shown in FIG. 3. The externally accessible internal memory 112 is inserted completely within the mobile audio-video receiver 100 and ejected via a mechanical eject button or an electro-mechanical ejection mechanism. In the alternative, the externally accessible internal memory can be configured such that the externally accessible internal memory is inserted into the mobile audio-video receiver but a tab portion of the externally accessible internal memory sticks out, which can be grasped for removal.

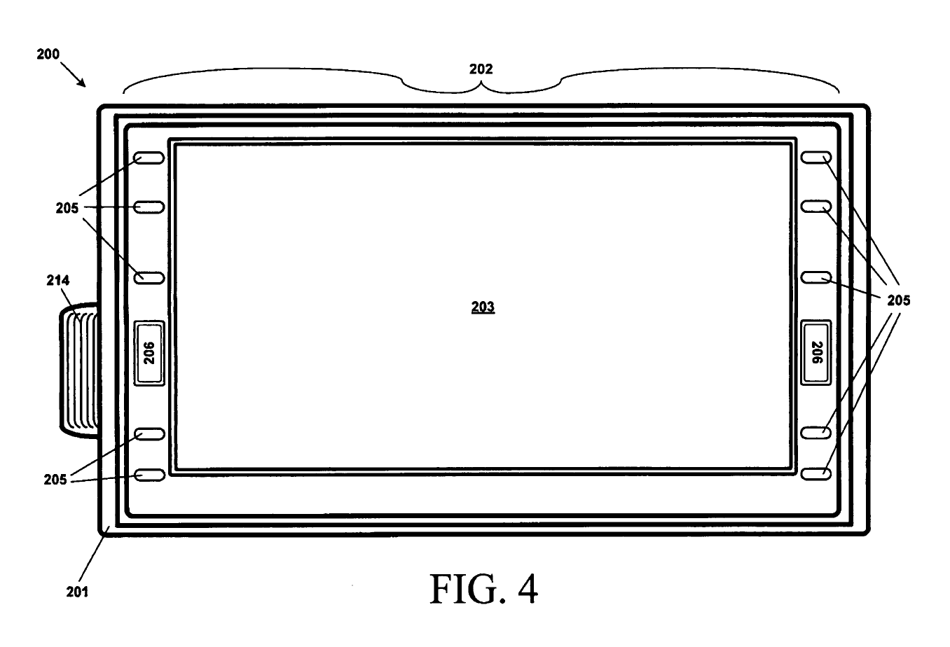

FIG. 4 is a front view of a double-DIN sliding front mobile audio-video receiver according to an embodiment of the present invention. The double-DIN sliding front mobile audio-video receiver 200 shown in FIG. 2 includes a sliding front 202 that slides down and out from a base 201 to allow access to a DVD player behind the sliding front 202. The DVD player behind the sliding front 202 can be a stack DVD player that holds a plurality of DVDs. A display screen 203 is position at the center of the sliding front 202. The display screen 203 can be a touch-panel display screen. Function buttons 205 are positioned along the sides of the sliding front 202. In addition, a rocker button 206 is positioned on each side of the display screen 203. A tab 214, which is attached to an externally accessible internal memory (not shown in FIG. 4), protrudes from an exterior side surface of the base 201, as shown in FIG. 4.

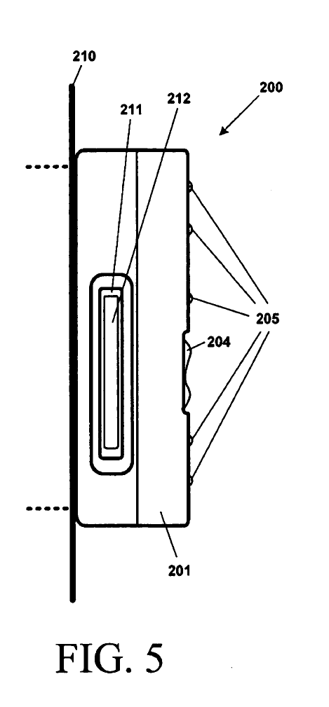

FIG. 5 is a side view of the double-DIN sliding front mobile audio-video receiver shown in FIG. 4. The base 201 of the mobile audio-video receiver 200 protrudes from the dash 210 or other mounting area of one of a vehicle or craft. An exterior side surface of the base 201 has a memory receptacle 211 for receiving an externally accessible internal memory 212. More particularly, the external memory receptacle 211 is in an exterior side surface of the base and configured such that an externally accessible internal memory 212 can be completely inserted into the base behind the sliding front panel 202. Thus, the externally accessible internal memory 212 can be completely within the base of the mobile audio-video receiver 200. Because the memory receptacle 211 can receive the externally accessible internal memory 212 such that the externally accessible internal memory 212 is completely within the mobile audio-video receiver 200 a tab portion 214 (shown in FIG. 4) is attached to the externally accessible internal memory 112 such that the tab portion 214 protrudes out of the a memory receptacle 211. The tab portion 214 can be grasped by a user so that the externally accessible internal memory 212 can be removed from the mobile audio-video receiver 200.

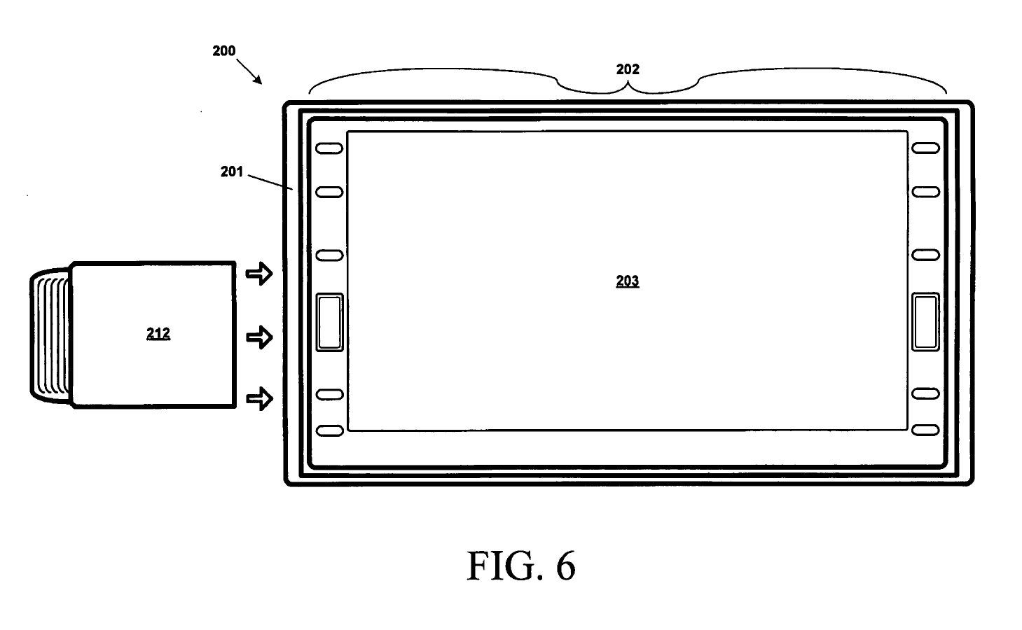

FIG. 6 is a front view of the double-DIN sliding front mobile audio-video receiver of FIG. 3 showing the insertion of an externally accessible internal memory with an attached tab. Because the mobile audio-video receiver 200 protrudes from the dash, the externally accessible internal memory 212 can be inserted into the side of the mobile audio-video receiver 200, as shown in FIG. 6. The externally accessible internal memory 212 is inserted completely within the mobile audio-video receiver 100 and removed by pulling the tab portion 214, which is attached to the externally accessible internal memory 212.

It will be apparent to those skilled in the art that various modifications and variations can be made in the mobile audio-video receiver with an external memory receptacle of the present invention without departing from the spirit or scope of the invention. Thus, it is intended that the present invention cover the modifications and variations of this invention provided they come within the scope of the appended claims and their equivalents.

What is claimed is:

1. A mobile audio-video receiver with an external memory receptacle, comprising:
a base containing circuitry and components for functions of the mobile audio-video receiver;
a front panel mounted on a front surface of the base;
a display screen on the front panel;
function buttons on the front panel for controlling the functions of the mobile audio-video receiver; and
an external memory receptacle positioned in a side surface of the base such that an externally accessible internal memory can be inserted into the base behind the front panel.

2. The mobile audio-video receiver of claim 1, wherein the front panel includes a sliding front panel that can slide down and away from the base.

3. The mobile audio-video receiver of claim 2, wherein a digital video disk player is located behind the sliding front panel.

4. The mobile audio-video receiver of claim 1, further comprising an eject button for ejecting the externally accessible internal memory from the mobile audio-video receiver.

5. The mobile audio-video receiver of claim 4, wherein the eject button is positioned adjacent to the memory receptacle at the side surface of the mobile audio-video receiver.

6. The mobile audio-video receiver of claim 1, wherein the external memory receptacle in the side surface of the base is configured such that the externally accessible internal memory can be completely inserted into the base behind the front panel.

7. The mobile audio-video receiver of claim 1, wherein the display screen is a touch-panel display screen.

8. The mobile audio-video receiver of claim 1, wherein at least some of the functions of the mobile audio-video receiver will not operate when the externally accessible internal memory is not installed in the memory receptacle.

9. A mobile audio-video receiver with an external memory receptacle, comprising:
a base containing circuitry and components for functions of the mobile audio-video receiver;
a front panel mounted on a front surface of the base;
a digital video disk player located behind the front panel;
a display screen on the front panel;
function buttons on the front panel for controlling the functions of the mobile audio-video receiver;
an external memory receptacle positioned in a side surface of the base; and
an externally accessible internal memory inserted into the external memory receptacle such that the externally accessible internal memory is in the base and behind the front panel.

10. The mobile audio-video receiver of claim 9, further comprising an eject button for ejecting the externally accessible internal memory from the mobile audio-video receiver.

11. The mobile audio-video receiver of claim 10, wherein the eject button is positioned adjacent to the memory receptacle at the side surface of the mobile audio-video receiver.

12. The mobile audio-video receiver of claim 9, wherein a tab portion is attached to the externally accessible internal memory and the tab portion protrudes out of the memory receptacle.

13. The mobile audio-video receiver of claim 9, wherein the external memory receptacle in the side surface of the base is configured such that the externally accessible internal memory can be completely inserted into the base behind the front panel.

14. The mobile audio-video receiver of claim 13, wherein a tab portion is attached to the externally accessible internal memory and the tab portion protrudes out of the memory receptacle.

15. The mobile audio-video receiver of claim 9, wherein the display screen includes a touch-panel display screen.

16. The mobile audio-video receiver of claim 9, wherein the externally accessible internal memory includes a memory drive.

17. The mobile audio-video receiver of claim 9, wherein at least some of the functions of the mobile audio-video receiver will not operate when the externally accessible internal memory is not installed in the memory receptacle.

18. A mobile audio-video receiver with an external memory receptacle, comprising:
a base containing circuitry and components for functions of the mobile audio-video receiver;
a sliding front panel mounted on a front surface of the base such that the front panel can slide down and away from the base;
a digital-video-disk player located behind the sliding front panel;
a display screen on the front panel;
the external memory receptacle positioned in a side surface of the base; and
an externally accessible internal memory completely inserted into the external memory receptacle such that the externally accessible internal memory is completely within the base and behind the sliding front panel,
wherein at least some of the functions of the mobile audio-video receiver will not operate when the externally accessible internal memory is not installed in the memory receptacle.

19. The mobile audio-video receiver of claim 18, further comprising an eject button for ejecting the externally accessible internal memory from the mobile audio-video receiver.

20. The mobile audio-video receiver of claim 18, wherein a tab portion is attached to the externally accessible internal memory and the tab portion protrudes out of the memory receptacle.
